(19) United States
(12) Patent Application Publication
(10) Pub. No.: US 2004/0093229 A1
(43) Pub. Date: May 13, 2004

(54) System and method for content distribution

(75) Inventor: Brent Alan Plain, Kingston (CA)

Correspondence Address: Nicholas J. Tuccillo, Esq., McCormick, Paulding & Huber LLP, CityPlace II, 185 Asylum Street, Hartford, CT, 06103, US

(73) Assignee: 1483790 ONTARIO INC., Kingston (CA)

(21) Appl. No.: 10/292,938

(22) Filed: Nov. 13, 2002

(51) Int. Cl. G06F 17/60; H04K 1/00

(52) U.S. Cl. 705/1; 705/14; 705/64

(57) ABSTRACT

A system for distributing content is provided. The system comprises a generation unit for generating a value associated with the content, a value distribution unit for distributing the value to users, a value receiving unit for receiving the value from a user, a validation unit for verifying the validity of the received value, a response unit for distributing the content in response to a valid value, and a repository for storing information regarding the value.

### CROSS REFERENCE TO RELATED APPLICATION

This application claims the benefit of U.S. Provisional Application No. 60/331,154, filed Nov. 9, 2001; Canadian Patent Application No. 2,361,876, filed Nov. 9, 2001; and Canadian Patent Application No. ______, filed Nov. 8, 2002, each of which are incorporated by reference in their entirety.

### FIELD OF THE INVENTION

The invention relates to a system and method for distributing content.

### BACKGROUND OF THE INVENTION

Owners of content, including digital media such as audio and/or video, and text files, routinely publish their works on the Internet. Once on the Internet, the digital content may be easily copied with or without permission from the digital content owner. Many digital content owners want to copy-protect, or control the accessibility of, their digital content.

Current digital rights management (DRM) technologies provide a means of copy-protecting digital content and issuing playback licenses to users. These DRM systems integrate the issuance of a playback license during an e-commerce transaction to purchase the license. For example, a user may visit a content provider's website and select a digital media file such as a song in decrypted format. The user may then download the digital media file via the website, by purchasing a license to use it. This transaction is limited to a one-time electronic purchase of a license to use the digital media file where the distribution of the media file is made electronically at the time of purchase. The transaction is made directly with the owner or licensee of the digital content by using the DRM system.

Current DRM systems do not provide a means for purchasing content protected by these systems other than in an e-commerce transaction as exemplified above. Such e-commerce transactions are initiated by the user when the user interacts with the copy-protected content, or requests a prior playback-license electronically. Even if the playback license remains separate from the related copy-protected content and the user requests a playback license separately, the transaction and installation of the playback license to the user's machine or playback device is purely electronic. Thus current DRM transactions may be completed through electronic means only, and further require the transactions to be made between the DRM system and a user.

There is a need in the art for a means of distributing content to users without the limitations outlined above.

### SUMMARY OF THE INVENTION

It is an object of the present invention to solve one or more of the problems described above.

In accordance with an embodiment of the present invention, there is provided a system for distributing content. The system comprises a generation unit for generating a value and for associating the value with a predetermined content, a repository for storing information regarding the value, a value distribution unit for distributing the value to users, a value receiving unit for receiving the value from a user, a validation unit for verifying the validity of the received value, and a response unit for distributing access to the predetermined content in response to a valid value.

In accordance with another embodiment of the present invention, there is provided a method of distributing content. The method comprises the steps of generating a value, associating the value with a predetermined content, storing information regarding the value, distributing the value to users, receiving the value from a user, verifying the validity of the received value, and distributing access to the predetermined content in response to a valid value.

In accordance with another embodiment of the present invention, there is provided a computer data signal embodied in a carrier wave and representing sequences of instructions which, when executed by a processor, cause the processor to perform a method of distributing content. The method comprises the steps of generating a value, associating the value with a predetermined content, storing information regarding the value, distributing the value to users, receiving the value from a user, verifying the validity of the received value, and distributing access to the predetermined content in response to a valid value.

In accordance with another embodiment of the present invention, there is provided computer-readable media for storing instructions or statements for use in the execution in a computer of a method of distributing content. The method comprises the steps of generating a value, associating the value with a predetermined content, storing information regarding the value, distributing the value to users, receiving the value from a user, verifying the validity of the received value, and distributing access to the predetermined content in response to a valid value.

In accordance with another embodiment of the present invention, there is provided a computer program product for use in the execution in a computer for a system for distributing content. The system comprises a generation unit for generating a value and for associating the value with a predetermined content, a repository for storing information regarding the value, a value distribution unit for distributing the value to users, a value receiving unit for receiving the value from a user, a validation unit for verifying the validity of the received value, and a response unit for distributing access to the predetermined content in response to a valid value.

### BRIEF DESCRIPTION OF THE DRAWINGS

Embodiments of the invention will now be described with reference to the accompanying drawings, in which:

FIG. 1 shows an example of an e-currency system in accordance with an embodiment of the present invention;

FIG. 2 shows a flowchart of an example of a method for generating e-currency values in accordance with an embodiment of the present invention;

FIG. 3 shows a flowchart showing a method of redeeming an e-currency value in accordance with an embodiment of the present invention;

FIG. 4 shows a flowchart of a method of using e-currency for distributing content in accordance with an embodiment of the present invention;

FIG. 5 shows another example of an e-currency system in accordance with an embodiment of the present invention;

FIG. 6 shows a flowchart of another method of using an e-currency system in accordance with an embodiment of the present invention;

FIG. 7 shows an overview of the interaction taking place in an e-currency system in accordance with an embodiment of the present invention;

FIG. 8 shows an example of an e-currency environment in accordance with an embodiment of the present invention;

FIG. 9 shows another example of an e-currency environment in accordance with an embodiment of the present invention;

FIG. 10 shows another example of an e-currency environment in accordance with an embodiment of the present invention;

FIG. 11 shows another example of an e-currency environment in accordance with an embodiment of the present invention;

FIG. 12 shows another example of an e-currency environment in accordance with an embodiment of the present invention.

### DETAILED DESCRIPTION OF EMBODIMENTS OF THE INVENTION

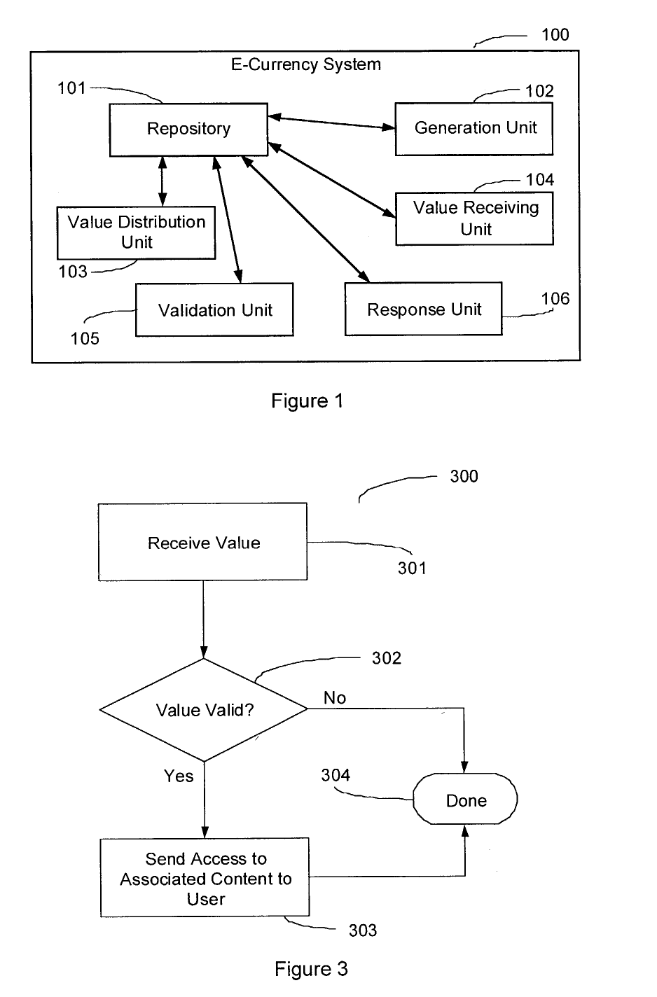

FIG. 1 shows an example of an e-currency system 100 in accordance with an embodiment of the present invention. The e-currency system 100 may create one or more e-currency values associated with content for distribution to consumers. The e-currency value may be redeemed by consumers for the associated content. Content which may be associated with the e-currency value include services, promotions, contests, electronic products, copy-protected electronic products, digital files, decryption keys, hard goods, contest prizes, information, access to streaming audio and/or video, and any other forms of content. Users can redeem e-currency for goods and services or a discount for such goods and services over the Internet, as an alternative to credit cards or bank cards. Uses may also redeem e-currency in other ways, such as e-currency printed on coupons to be redeemed in commercial establishments. Some examples of content and redemption of e-currency will be further described below.

The e-currency system 100 comprises a repository 101, a generation unit 102, a value distribution unit 103, a value receiving unit 104, a validation unit 105, and a response unit 106. The e-currency system 100 may further comprise a billing unit for billing consumers and/or other users of e-currency. The components of the e-currency system 100 will be further described with reference to FIGS. 1, 2 and 3.

The repository 101 stores e-currency values along with lists of associated content for which the e-currency values may be redeemed. The repository may also store information regarding the e-currency values such as who ordered the generation of the e-currency values, whether or not the e-currency values have been used, and administrative information as desired. The repository 101 may be a database comprising various fields and tables to store information regarding the e-currency values. Other components of the e-currency system 100 may communicate with the repository 101 to obtain information used to carry out the functions of the other components. Alternatively, the e-currency system 100 may contain a central processing unit which communicates and coordinates functionality between the components of the e-currency system 100.

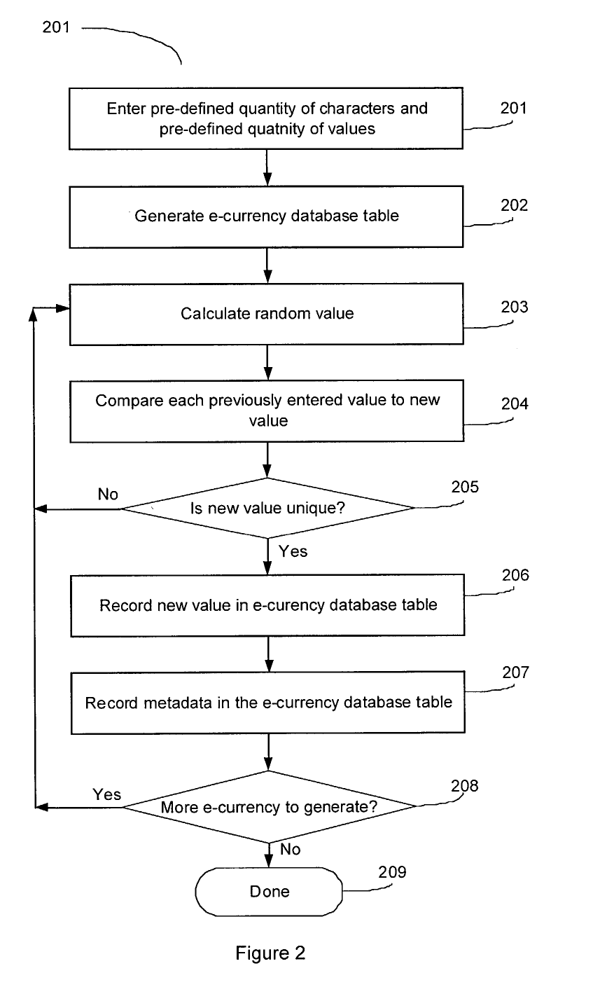

The generation unit 102 generates a random, alphanumeric e-currency value that is associated with the content. For example, “AC362KOTB8” may be an e-currency value. The generation unit 102 may comprise known random number generation means. FIG. 2 shows an example of the preferred process logic or method (200) for generating e-currency values in an embodiment of the e-currency system 100. The method begins with entering a pre-defined quantity of characters and a pre-defined quantity of e-currency values into the generation unit 102 (201). The pre-defined quantity of characters may be any integer greater than zero. Typically, the pre-defined quantity of characters may be 10. Increasing the number of characters will increase the security of the e-currency value. The security features of an e-currency value will be described below. An e-currency series is a pre-defined quantity of e-currency values which correlate to a specific content. The e-currency values in an e-currency series are unique and non-sequential.

The generation unit 102 generates a database table or tables, and related fields in the repository 101 to store data (202). The generation unit 101 calculates a random e-currency value, preferably at base-32 using English language characters and numbers (203). Before a new e-currency value is recorded to the database field, the entire corresponding table or tables are read and each previously entered e-currency value is compared to the new e-currency value (204). If the new e-currency value is not unique (205), then another random e-currency value is calculated (203). If the new e-currency value is unique (205), it is recorded to the table (206). Metadata corresponding to the associated content are recorded within the repository 101 to correlate the e-currency values with a content (207). Preferably, the e-currency is discretely associated with one content. Other fields may be created in the database table to store desired information pertaining to the generated e-currency value. This process is repeated through the quantity of e-currency values previously determined. If there are more e-currency values to generate (208), then another random e-currency value is calculated (203). If there are no more e-currency values to generate (208), then the generation method (200) is done (209).

Once an e-currency value is generated it is available to be distributed to users of e-currency. The value distribution unit 103 distributes the e-currency value to users of e-currency. One example of a value distribution unit 103 is code which sends a user the e-currency value electronically over a network. For example, a user may visit a website to order e-currency. The user may order one or more e-currency values which may be either displayed to the user or sent to the user via electronic mail. Alternatively, the user may order or receive e-currency values through traditional channels of trade, including telephone or voice mail, and physical channels such as paper order forms and printed e-currency values physically distributed to a user. A user may also order e-currency to be distributed to other users. Furthermore, e-currency values which are not consumed may be transferable amongst consumers and other users of e-currency.

Users possessing e-currency values may redeem them for the content associated with them. FIG. 3 shows a flow chart of an example of a method for the redemption of e-currency (300) in accordance with an embodiment of the e-currency system 100. The value receiving unit 104 receives an e-currency value from a user (301). A user may be a consumer of e-currency or a dealer of e-currency. Examples of consumers and dealers will be described below.

The value receiving unit 104 is code designed to electronically receive an alphanumeric e-currency value. Using customized software, a user may transmit the alphanumeric e-currency value, or e-currency value, over a network such as the Internet to the value receiving unit 104. Alternatively, the user may transmit the alphanumeric e-currency value over a telephone or other telecommunication network to the value receiving unit 104 designed to receive voice input, or to an operator who, in turn, will enter the e-currency value into the value receiving unit 104.

One example of a consumer of e-currency is a customer wishing to redeem an e-currency value online in order to purchase a decryption key to view an encrypted digital file. An example of a dealer of e-currency is a digital video content provider wishing to sell or distribute e-currency f0or consumers to redeem for a decryption key needed to view an encrypted digital video file. In such a scenario, the consumer may enter the e-currency value online through customized software that will be transmitted over a network to the value receiving unit 104.

Another example of a consumer of e-currency is a customer wishing to redeem an e-currency value printed on a coupon in order to purchase an item in a commercial establishment. Another example of a dealer of e-currency is the commercial establishment which sells or distributes e-currency to customers who may then redeem an e-currency value for an item for sale in the commercial establishment. In such a scenario, either the customer or an employee of the commercial establishment may communicate the printed e-currency value to the value receiving unit 104 through a data or telecommunication network as described above.

Once receiving an e-currency value from a user, the value receiving unit 104 passes the e-currency value to the validation unit 105. The validation unit 105 determines whether the e-currency value received from the user is valid (302). The validation unit 105 validates an e-currency value by comparing the e-currency value against e-currency values in the repository 101. If a matching e-currency value exists that has not already been used, then the e-currency value is valid. At the time of redemption, the e-currency value may be flagged as being consumed by adding a logical value to a field within the relevant data record where the e-currency value is stored. Alternatively, the e-currency value may be deleted from the data table so that it may not be used again. In either case, at this time the e-currency value has been consumed, and will no longer be valid for redemption. An example of the validation of an e-currency value will be further described below.

The validation unit 105 will pass the e-currency value and its status to the response unit 106. If the e-currency value is valid (302), then the response unit 106 will send access to content associated with the valid e-currency value to the user (303) in response to receiving such an e-currency value. In performing this step (303), the response unit 106 may communicate with the repository 101 to determine the content associated with the e-currency value. The response unit 106 may then send access to the content to the user and the redemption is done (304). Forms of sending access to the content (303) will be described below. If the e-currency value is not valid (302), then the response unit 106 may either send an error response to the user or not response to the user at all and the redemption attempt is done (304).

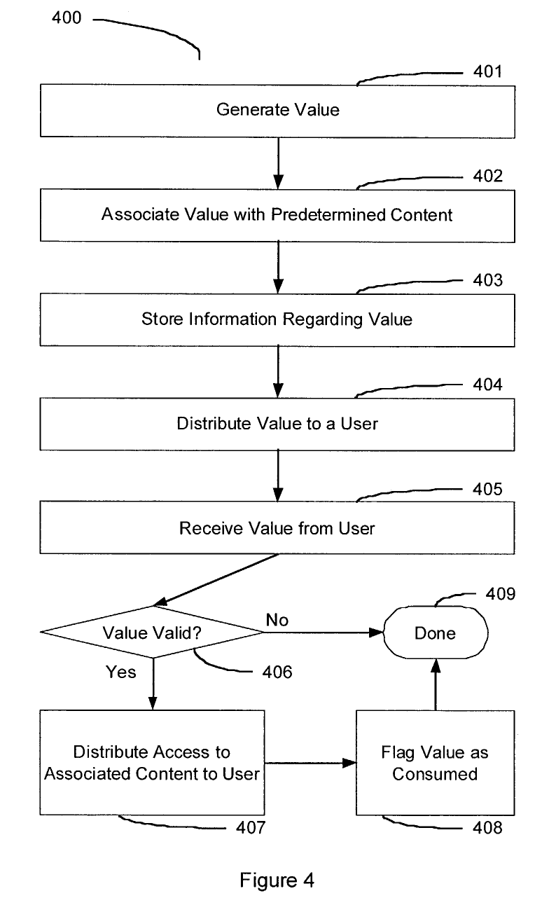

FIG. 4 shows a flowchart of a method for using e-currency for content distribution (400) in accordance with an embodiment of the e-currency system 100. The method begins with the generating a value (401). The generation (401) may comprise generating random values comprising ten alpha-numeric base-32 characters. Next, the value is associated with predetermined content (402). The association (402) may include assigning to the value a content access file corresponding to the predetermined. Furthermore, information regarding the value, such as its associated content or content access file, is stored (403). The information regarding the value may also include whether or not the value has been used. The information may be stored in a repository 101, such as a database comprising fields and tables. Next, the value is distributed to a user (404) so that the value may be redeemed for the content. The distribution (404) may involve electronically distributing a digital file to the user or distributing the value to the user in printed form on hard goods.

To redeem the content, the e-currency system 100 receives a value from the user (405) and verifies the validity of the received value (406). In this example, the value received must be the same as the value generated. Furthermore, the value must not have been used. If the value is not valid (406), then an error response may be given to the user. Alternatively, no response may be given at all, the value is ignored, and the method is done (409). If the value is valid (406), then access to the associated predetermined content is distributed to the user (407) and the value is flagged in a field of the repository 101 as consumed (408). Alternatively, the value may be deleted from the repository 101 so that it cannot be reused. Sending access to the predetermined content (407) may include sending the predetermined content to the user or sending an access file used to access the predetermined content to the user. Other forms of access to content may be applied in this sending step (407). Once the value is used, the method is done (409).

Other steps may be added to the method for using e-currency for content distribution (400).

Embodiments of the e-currency system 100 may be applied to digital content which may be made available over networks, including the Internet, and/or available on fixed media storage device means such as CD-ROM, DVD-ROM or similar media used to store data. Such digital content may include audio files, video files and text files copy-protected with standard copy-protection technologies, including encryption and digital rights management (DRM), that provide a way to copy-protect digital content, and issue playback licenses to users. In some embodiments described in this specification, DRM technologies will sometimes be referred to when discussing standard copy-protected technologies. However, the embodiments are not limited to DRM. Other forms of copy-protection may be used.

In one example of an embodiment of the e-currency system 100, e-currency for content distribution provides a digital currency that may be redeemed for one or more standard playback license files for copy-protected digital content. The digital currency, or e-currency value, remains separate from the digital content files and playback license files. Advantageously, this allows copy-protected digital content files to be distributed to users without exposing the content. The e-currency value may also be distributed to users with or without the copy-protected digital content files. Electronic tickets or e-currency may be represented as a unique alpha-numeric e-currency value, which can be redeemed by consumers for a playback license file. For example, the playback license file may be in the form of a decryption key, which may be used to decrypt an encrypted digital content file. Another example of a playback license may be in the form of a DRM license file, which may be used to access content protected with DRM software. The playback license will be referred to as the digital content access file.

The e-currency value is adjunct from a DRM system, i.e., e-currency operates independently from DRM software. The e-currency value may be used in association with DRM software to correlate to specific content which is copy-protected using DRM software. For example, the e-currency value may be redeemed for a DRM playback license. Users can use this electronic currency as an alternative to direct online e-commerce transactions to obtain DRM playback licenses. E-currency value may be distributed both electronically, and through hard-copy forms.

Another aspect of an embodiment of the e-currency system 100 provides a means of distributing e-currency value in the form of vouchers through digital means such as the electronic distribution of unique, one-time use, alpha-numeric e-currency values over networks such as electronic mail and websites, and/or analogue means such as unique, one-time use, alpha-numeric e-currency values printed in hard-copy form. The e-currency value can be distributed through channels outside of the owner of the DRM system. Therefore, advantageously, the form and distribution methods of the e-currency system are not restricted to digital means, while the redemption transactions of the e-currency value may be digital over networks.

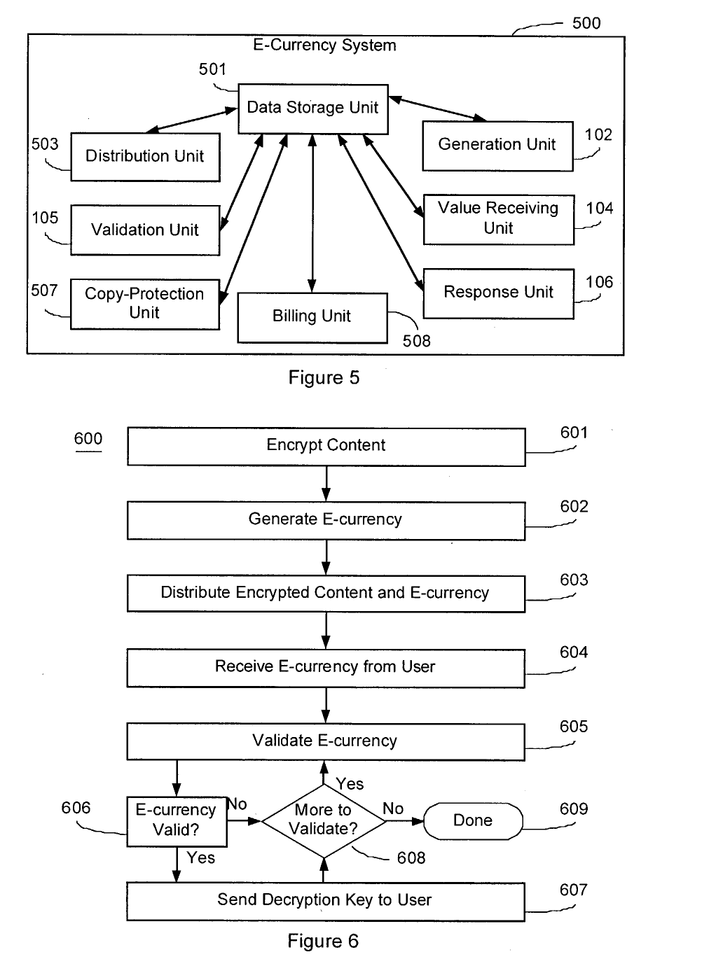

One aspect of an embodiment of the e-currency system consists of an interaction between a user's computer and an e-currency server. The e-currency server contains an e-currency system 500. FIG. 5 shows another example of an e-currency system 500. The e-currency system 500 comprises a data storage unit 501, a generation unit 102, a distribution unit 503, a value receiving unit 104, a validation unit 105, a response unit 106, a copy-protection unit 507, and a billing unit 508. These units may be software code or code embedded in hardware. The generation unit 102, value receiving unit 104, validation unit 105, and response unit 106 are similar to those described above. Components may be removed or added to the e-currency system 500.

The data storage unit 501 stores e-currency values along with lists of correlated digital content access files. The digital content access files are used to access copy-protected digital content files. A digital content file may comprise any file which may be digitally stored, including a digital media file. The data storage unit 501 may be a database. The data storage unit 501 may contain data records with fields that flag whether or not the e-currency has been used. Other components of the e-currency system 500 may communicate with the data storage unit 501 to obtain information used to carry out the functions of the other components. Alternatively, the e-currency system 500 may contain a central processing unit which communicates and co-ordinates functionality between the components of the e-currency system 100.

The generation unit 102 of the e-currency system 500 generates unique and random alpha-numeric e-currency values, preferably base-32, at any character length but typically 10-characters. Other types of e-currency values of different bases may also be generated. The resulting e-currency are stored in the data storage unit 501 and are referred to as the e-currency values, but may also be named e-ticket numbers, or PINs, or E-PINs, or e-serial numbers.

After an e-currency value has been created by the generation unit 102, it may be distributed to users who may redeem an e-currency value for its associated digital content access file over the Internet or other computer networks. The distribution unit 503 may distribute copy-protected digital content files and e-currency values to users. For example, the distribution unit 503 may distribute copy-protected digital content files and e-currency values to a content provider or dealer of e-currency. In turn, the content provider or dealer of e-currency redistributes the copy-protected digital content files and e-currency to consumers of e-currency.

To use e-currency, an e-currency user proceeds to a designated webpage on the Internet where the user can enter an e-currency value. The value receiving unit 104 receives the e-currency value and passes it to the validation unit 105. The validation unit 105 validates the e-currency value received from the user. The validation may involve matching the e-currency value with the correlated digital content access file. The validation unit 105 validates the entry by comparing the e-currency value against e-currency values that were entered into a data storage unit 501, such as a relational database, during the generation of an e-currency value series. If a matching e-currency value exists that has not already been used, then the user is authorized to redeem the e-currency value for its associated digital content file. At the time of redemption, the e-currency value is flagged as being consumed by adding a logical value to a field within the relevant data record where the e-currency value is stored. At this time the e-currency value has been consumed, and is no longer valid for redemption.

Original digital content may be provided to the e-currency system by a dealer of e-currency, such as a content provider. The digital content may require copy-protection. The copy-protection unit 507 copy-protects a digital content file and generates a digital content access file to access the copy-protected digital content file. The copy-protection unit 507 may be standard encryption means, where the digital content access file is a decryption key. Alternatively, the copy-protection unit 507 may be DRM means, where the digital content access file is a DRM playback license. Other forms of copy-protection may be used.

In another embodiment of the e-currency system 500, a collection of digital audio files is collected and stored into an “e-album”. The e-album is then copy-protected and e-currency is generated and associated with the digital content access file needed to access the copy-protected e-album. The e-album may be stored on a web site. A user may browse e-album titles or samples listed on the web site and download a desired e-album. Next, the user may purchase or obtain an e-ticket. When the user double clicks on the downloaded e-album file, a program will prompt the user to input an e-currency number. The user enters the e-currency number and the e-currency is sent to the e-currency system 500. The program on the user's computer receives the digital content access file associated with the e-album. The program may now access the copy-protected e-album and play the e-album for the user.

Users may be billed for the purchase of the e-currency values. Content providers may be billed for the creation of the e-currency values, as well as the overall e-currency value service and maintenance of the e-currency system 500. The billing unit 508 bills users and/or content providers for the e-currency values. For example, users may purchase an e-currency value for a fixed price, such as $5.00. Alternatively, users may purchase a group of e-currency values for a group rate, such as 10 e-currency values for $30.00. Other billing schemes may be applied to the sale or distribution of the e-currency values. Furthermore, distributors or dealers of e-currency may be billing for the use of the e-currency system 100, 500 and/or the service of e-currency distribution.

Parts of the remainder of this specification will describe an e-currency system with reference to the e-currency system 500 shown in FIG. 5. With appropriate modifications, the description in these parts of the remainder of the specification may be applied to the e-currency system 100 shown in FIG. 1.

FIG. 6 shows a method for assisting in the exchange of digital content (600). The method begins with copy-protecting the digital content through standard copy-protection means, and generating a digital content access file to access the copy-protected digital content file (601). Next, one or more e-currency values associated with the digital content access file are generated and stored in the data storage unit 501 along with their associated digital content access files (602). Copies of the copy-protected digital content file and e-currency value (or e-currency values) may now be distributed to users (603). The distribution of the e-currency value to a user may be performed directly by an e-currency system 500 server to the user's computer. Alternatively, the copy-protected digital content file and e-currency value may be sent to a distributor, or to the owner or provider of the original content, to be distributed to users. Once the e-currency is distributed to users (603), a user may submit an e-currency value to the e-currency system 500. The e-currency system 500 receives the e-currency value from the user (604). Next, the e-currency system 500 validates the e-currency value (605). The validation (605) may include searching the data storage unit 501 for the associated decryption key and determining that the key has not already been redeemed. If the e-currency value is valid (606), the e-currency system 500 sends the digital content access file to the user (607). Otherwise, the digital content access file is not sent to the user. An error message declining the exchange may be returned to the user with or without the e-currency value unit. Once the user receives the digital content access file, or the system 500 rejects the submitted e-currency value, the system 500 checks to see if there is another e-currency value to validate (608). If there are more e-currency values to validate (608), then the next e-currency value is validated (605). If there are no more e-currency values to validate (608), then the method (600) is done (609). Further steps may be added to the method including flagging a redeemed e-currency value as consumed, receiving an original digital content file from a content owner, billing the content owner, and billing the user. Furthermore, a content owner may provide content which is not in digital format. Such content may be converted to digital format using standard conversion means as a further step in the method.

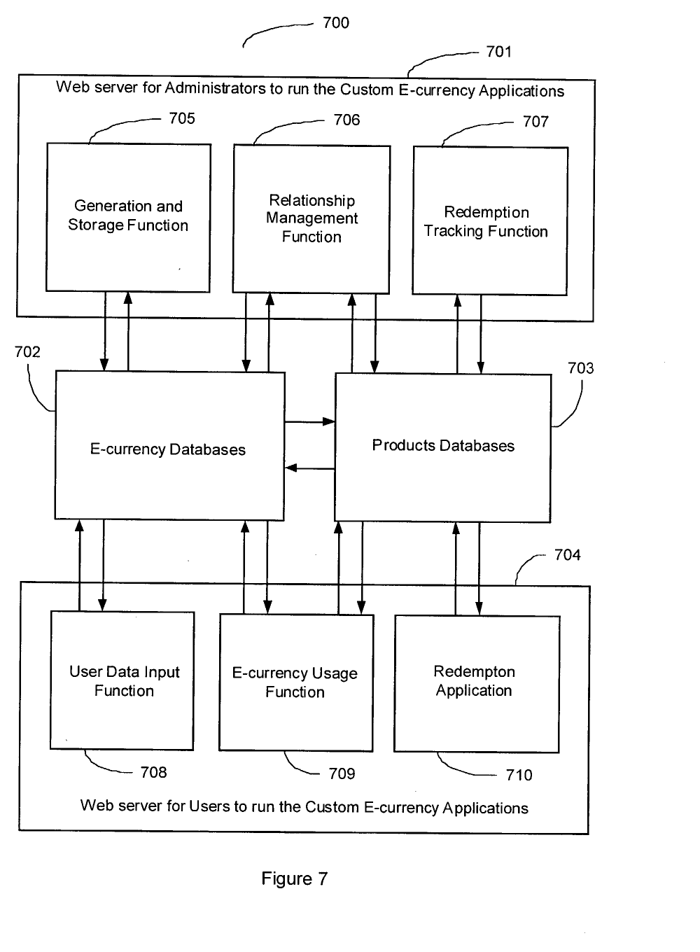

FIG. 7 shows, in another example of an embodiment of the e-currency system 500, the interaction between a web server for administrators to run custom e-currency applications 701, e-currency databases 702, products databases 703, and a web server for users to run the custom e-currency applications 704. The web server for administrators 701 comprises an e-currency generation and storage function 705, a relationship management function 706, and a redemption tracking function 707. The generation and storage function 705 may use the generation unit 102 and the data storage unit 501 to generate the e-currency values, output the e-currency values to text files, and store the e-currency values in tables within an e-currency database 702. The relationship management function 706 may create relationships and reports and assist in maintaining tasks relating to e-currency usage relative to specific products for which e-currency may be redeemed. The relationship management function 706 may operate on both e-currency databases 702 and products databases 703. The redemption tracking unit 707 may create, maintain and report on tables in a digital content file database 703.

The e-currency databases 702 may comprise a database running in a database management system manger, including a SQL manager. The products databases 703 may comprise a database running in a database management system manager SQL manager. The products in the products databases 703 may include digital content access files, decryption keys, and/or other content described above. The e-currency databases 702 may communicate with the products databases 703.

The web server for users 704 comprises a user data input function 708, an e-currency usage function 709, and a redemption application 710. The user data input function 708 may input into the e-currency databases 702, user data relating to e-currency value, name, e-mail, and other user information. The e-currency usage function 709 may operate on the e-currency databases 702 and products databases 703. The e-currency usage function 709 may assist in the validation, redemption, and verification of e-currency for products for which e-currency may be redeemed. The redemption application 710 may comprise an application relating to the decryption keys received by the user in exchange for e-currency.

Examples of e-currency environments will now be described.

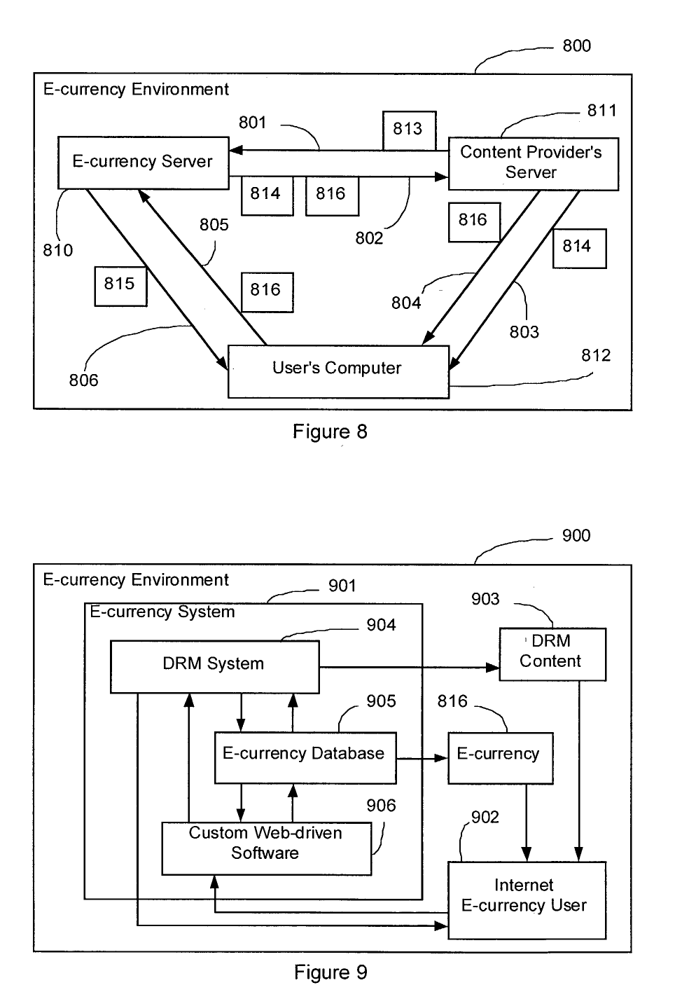

FIG. 8 shows an example of an e-currency environment 800 in accordance with another embodiment of the e-currency system 500. FIG. 8 shows processes for the creation of the e-currency (801 and 802), the distribution of the e-currency (803 and 804), and the use of the e-currency (805 and 806). FIG. 8 also shows an e-currency server 810, a content provider's web server 811, a user's computer system 812, a non copy-protected digital content file 813, an encrypted digital content file 814, a decryption key 815 and e-currency 816.

In the creation of e-currency 816, the content provider of audio, video and/or text products may provide raw audio, video, and or text content in the form of a non copy-protected digital content file 813 to the e-currency server 810 (801). The non copy-protected digital content file 813 is encrypted, using standard encryption means on the e-currency value server 810, by the encryption unit 102. E-currency 816 is generated using the generation unit 102 (not shown) on the e-currency system 500 (not shown) on the e-currency server 810. E-currency 816 may be redeemable for decryption keys for the encrypted digital content file 814. The e-currency 816 and the encrypted digital content file 814 are sent to the content provider (802).

In the distribution of the e-currency 816, the content provider may distribute the encrypted digital content file 814, and the e-currency 816 over the Internet, or through other channels of distribution (803 and 804). The encrypted digital content file 814 may be distributed by any digital means. The e-currency 816, typically represented as a unique 10-character e-currency value, may be distributed by any means that will convey the e-currency to the user. The user may receive a copy of the digital content file 814 separately from an e-currency value 816. The digital content file 814 may be freely distributed without fear of unauthorized use because it is encrypted. The e-currency value 816 may be purchased by consumers of e-currency or otherwise distributed to consumers of e-currency.

In the use of the e-currency value 816, when the user attempts to play the encrypted digital content file 814, the user is directed online over the Internet to the e-currency server 810 that issued the e-currency 816 and encrypted digital content file 814. The user is prompted by the value receiving unit 104 (not shown) to enter a valid e-currency value 816 (705). The validation unit 105 (not shown) of the e-currency system 500 (not shown) on the e-currency server 810 authorizes the number. If the e-currency value 816 is valid, the response unit 106 (not shown) sends the associated key 815 to the user's computer 812 (806). The decryption key 815 allows access to the encrypted digital content file 814. The e-currency value 816 entered by the user is tagged as consumed, and cannot be used again.

FIG. 9 shows another example of an e-currency environment 900 where DRM copy-protected products can be delivered prior to redemption of e-currency. FIG. 9 shows an e-currency system 901, an Internet e-currency user 902, DRM content 903, and e-currency 816. The e-currency system 901 comprises a DRM system 904, an e-currency database 905, and custom web-driven software 906. E-currency 816 may be created by the custom web-driven software 906 and stored in the e-currency database 905. The custom web-driven software 906 may also operate on the DRM system 904. The e-currency database 905 may communicate with the DRM system 904 to determine the relationships between e-currency 816 and DRM content. The e-currency database 905 may send e-currency 816 to the Internet e-currency user 902. The DRM system 904 may send encrypted DRM content to the Internet e-currency user 902. The Internet e-currency user 902 may redeem the e-currency using the custom web-driven software in exchange for the key to decrypt the DRM content 903. This key may be sent to the user 902 by the DRM system 904 after the validation of the e-currency 816 by the custom web-driven software 906 accessing the e-currency database 905. The user may then use the key to decrypt the DRM copy-protected products.

As has been described above, e-currency also has applications outside of DRM related transactions. For example, e-currency may be associated with hard-goods, contests, customer rewards programs, and discount coupons where the redemption of the unique alpha-numeric value of each e-currency value occurs online. Therefore, the products associated with the e-currency do not need to be in a digital form.

E-currency may be used to distribute rights to Internet content such as audio, video, discount coupons, vouchers, contests, tickets, customer rewards programs, and product promotions. A product may be a contest element where a consumer can instantly win a prize. In such a scenario, a pre-determined quantity of e-currency values are flagged as winning e-currency values by adding a corresponding logical field within the corresponding record within the e-currency database table. A product may also be a hard or soft product or service. In this scenario, the product metadata is added to another field within each database record which stores an e-currency value. If the product represents points in a customer rewards program, then corresponding data is stored relative to the amount of points or monetary value of each particular e-currency value generated.

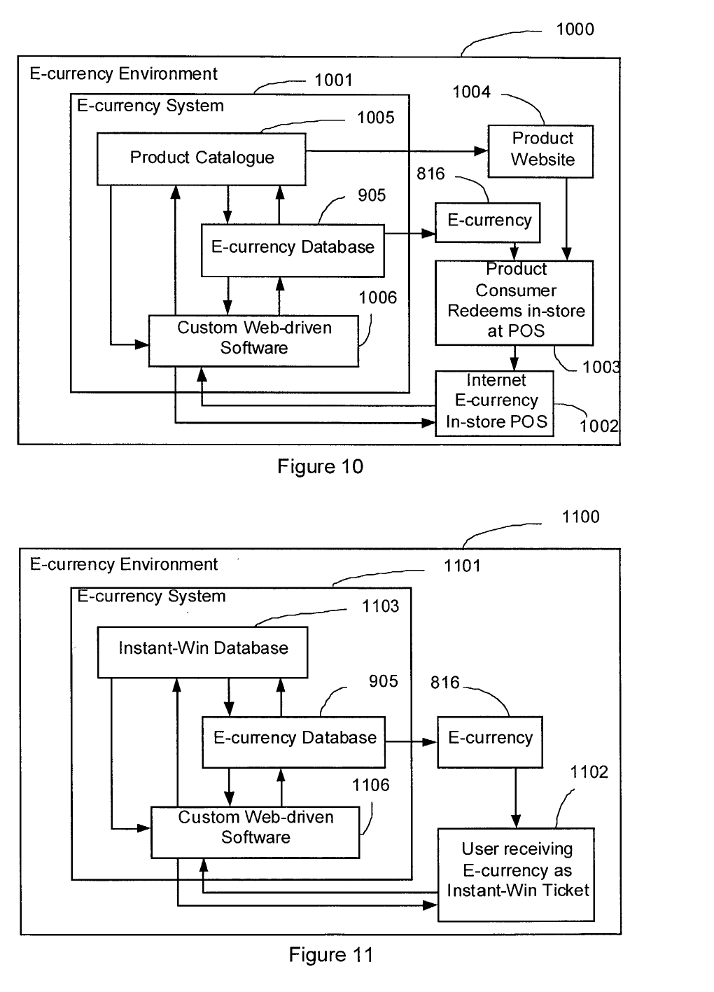

FIG. 10 shows another e-currency environment 1000 where products are delivered by traditional means after redemption of e-currency. FIG. 10 shows an e-currency system 1001, an Internet e-currency value in a store at a point of sale 1002, a product a consumer redeems in a store at a point of sale 1003, a product website 1004, and e-currency 816. The e-currency system 1001 comprises a product catalogue 1005, an e-currency database 905, and custom web-driven software 1006. E-currency 816 may be created by the custom web-driven software 1006 and stored in the e-currency database 905. The custom web-driven software 1006 may also operate on the product catalogue 1005. The e-currency database 905 may communicate with the product catalogue 1005 to determine the relationships between e-currency 816 and products in the product catalogue 1005. The e-currency database 905 may send e-currency 816 to a user. The product catalogue 1005 may send product information to the custom web-driven software 1006 and to the product website 1004. A user may redeem e-currency 816 during a point of sale in a store associated with the website 1004. The e-currency value 816 may be validated through the Internet in-store at a point of sale 1002 communicating with the custom web-driven software 906. Once the e-currency value 816 is validated, the products may then be given or sent to the user through traditional means.

FIG. 11 shows another e-currency environment 1100 where e-currency as Instant Win ticket numbers are delivered by traditional means and/or electronically. FIG. 11 shows an e-currency system 1101, a user receiving e-currency as an instant-win ticket 1102, e-currency 816, an instant-win database 1103, an e-currency database 905, and custom web-driven software 1106. The instant-win database 1103 stores winning numbers, and all user redemptions and communicates with the custom web-driven software. The e-currency database 905 communicates with the custom web-driven software 1106 and the instant-win database 1103. The e-currency database 905 may issue e-currency 816 to a user as instant-win tickets 1102. The user may communicate with the custom web-driven software 1106 to validate and play the instant-win ticket.

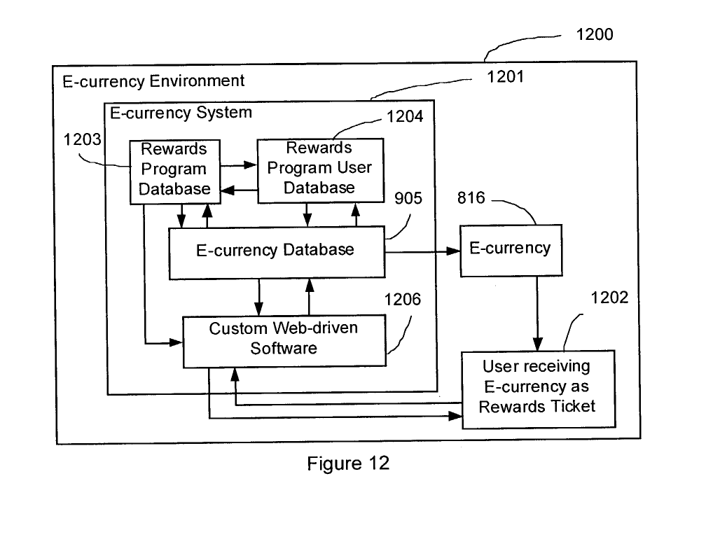

FIG. 12 shows another e-currency environment 1200 where e-currency as Rewards Program Tickets are delivered by traditional means and/or electronically. FIG. 12 shows an e-currency system 1201, a user receiving e-currency as rewards tickets 1202, e-currency 816, a rewards program database 1203, a rewards program user database 1204, an e-currency database 905, and custom web-driven software 1206. The rewards program database 1203 stores the value of points, and all user redemptions are stored in the rewards program user database 1204 and communicates with the custom web-driven software 1206. The e-currency database 905 communicates with the custom web-driven software 1206, the rewards program database 1203, and the rewards program user database 1204. The e-currency database 905 may issue e-currency 816 to a user as rewards program tickets 1202. The user may communicate with the custom web-driven software 906 to validate and use the rewards tickets.

E-currency for digital content distribution provides many advantages over traditional content distribution. One advantage provided by e-currency includes the fact that commerce transactions for copy-protected digital content, hard or soft goods, tickets, contests, or rewards programs can occur outside of the actual system, i.e., the transaction is not limited to an online transaction. Copy-protected digital content can be distributed in any digital format. Another advantage provided by e-currency value includes the fact that e-currency can be distributed through many levels of sales such as wholesalers and retailers. Another advantage provided by e-currency includes the fact that e-currency value can be distributed either electronically, or through print, and on packaged goods.

Another advantage provided by e-currency includes the fact that e-currency provides a high-level of security against arbitrary entry of non-valid e-currency values using a base-32 random system with stored e-currency values in relatively small tables. Since the e-currency values are random, non-sequential and unique, the odds of entering an arbitrary e-currency value with the equivalent amount of characters is greater than one in one million, which can be increased by adding more characters to the length of the e-currency values.

Another advantage provided by e-currency is that content, such as copy-protected digital files, may be distributed to users separately from the digital content access file and/or e-currency. This allows the content to be distributed to users without granting access to the content. In fact, in one example of an embodiment of the e-currency system 500, users may make copies of the copy-protected digital content files, thereby assisting in the distribution of same. These copied content-protected digital content files would remain copy-protected. Users may then want to purchase e-currency values to redeem for the digital content access file needed to access the copy-protected digital content. Since the copy-protected content files may be distributed separately, an e-currency system 500 need only store the digital content access files and the associated e-currency values. The copy-protected content files need not be stored in the e-currency system 500, thus saving disk storage space.

In another example of an embodiment of the e-currency system 500, a content provider need only supply content to an e-currency service provider. The e-currency service provider may then convert the content into a digital format and copy-protect the content. The copy-protected content may then be distributed to users, either by sending users a fixed media storage device means such as a floppy disk or CD-ROM, or making the copy-protected digital content file available on the Internet for users to download. The content provider may then receive from the e-currency service provider the e-currency to distribute to users. The e-currency values may be stored and distributed in an electronic format or printed on a hard-copy format for non-electronic communication. The content provider may distribute e-currency values for users to access the copy-protected digital content file without any computer or Internet expertise. Thus, in this example, a content provider would not need to install and maintain a computer system for distributing the copy-protected digital content or the e-currency values.

The system and method for e-currency for content distribution may be implemented by any hardware, software or a combination of hardware and software having the above-described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present invention, as well as the hardware, software and the combination thereof.

While specific embodiments of the present invention have been described, various modifications and substitutions may be made to such embodiments. Such modifications and substitutions are within the scope of the present invention, and are intended to be covered by the following claims.

What is claimed is:

1. A system for distributing content, the system comprising:
a generation unit for generating a value and for associating the value with a predetermined content;
a repository for storing information regarding the value;
a value distribution unit for distributing the value to users;
a value receiving unit for receiving the value from a user;
a validation unit for verifying the validity of the received value; and
a response unit for distributing access to the predetermined content in response to a valid value.

2. The system as claimed in claim 1, wherein the value is a sequence of alphanumeric characters.

3. The system as claimed in claim 1, wherein the repository is a database comprising fields and tables for storing information regarding the value.

4. The system as claimed in claim 1, wherein the generation unit is a random number generating means for generating random values comprising a sequence of characters.

5. The system as claimed in claim 1, wherein the value distribution unit comprises means for electronically distributing a digital file to the user.

6. The system as claimed in claim 1, wherein the value distribution unit comprises means for distributing the value to the user in printed form on hard goods.

7. The system as claimed in claim 1, wherein the value receiving unit comprises graphical user interface means for receiving the value from the user.

8. The system as claimed in claim 1, wherein the predetermined content is a digital content access file.

9. The system as claimed in claim 8, further comprising a digital content receiving unit for receiving the digital content access file.

10. The system as claimed in claim 9, wherein the digital content access file is one of a digital decryption key file and a digital rights management playback license file.

11. The system as claimed in claim 8, further comprising a digital content receiving unit for receiving unencrypted digital content.

12. The system as claimed in claim 11, wherein the unencrypted digital content is one of a digital media file and a digital text file.

13. The system as claimed in claim 11, further comprising a copy-protection unit for copy-protecting the unencrypted digital content and generating a digital content access file to access the digital content.

14. The system as claimed in claim 13, wherein the copy-protection unit comprises encryption means for encrypting digital files and generating an associated digital decryption key to decrypt the encrypted digital file.

15. The system as claimed in claim 13, wherein the copy-protection unit comprises digital rights management means for copy-protecting a digital content file and generating an associated digital file containing playback usage rights to access the copy-protected digital content file.

16. The system as claimed in claim 8, further comprising a content receiving unit for receiving non-digital content and converting the non-digital content into digital content.

17. The system as claimed in claim 8, further comprising a content distribution unit for distributing the encrypted digital content access file to a user.

18. The system as claimed in claim 1, further comprising a product catalogue unit for displaying products available for purchase in response to the value.

19. The system as claimed in claim 1, wherein the predetermined content is one of a lottery number and a rewards program point.

20. The system as claimed in claim 19, further comprising a lottery number database for storing a winning lottery number and a value redemption by the user.

21. The system as claimed in claim 19, further comprising a rewards program database for storing the reward program point and a value redemption by the user.

22. The system as claimed in claim 1, further comprising a billing unit for charging a fee for the purchase of the value.

23. The system as claimed in claim 22, wherein the billing unit comprises graphical user interface means to charge a fee to the user.

24. A method of exchanging content, the method comprising the steps of:
generating a value;
associating the value with a predetermined content;
storing information regarding the value;
distributing the value to users;
receiving the value from a user;
verifying the validity of the received value; and
distributing access to the predetermined content in response to a valid value.

25. The method as claimed in claim 24, further comprising the step of flagging a received valid value as consumed.

26. The method as claimed in claim 24, wherein the value is a sequence of alphanumeric characters.

27. The method as claimed in claim 24, wherein the generation step comprises the step of generating random values comprising a sequence of alpha-numeric characters.

28. The method as claimed in claim 24, wherein the value distribution step comprises the step of electronically distributing a digital file to the user.

29. The method as claimed in claim 24, wherein the value distribution step comprises distributing the value to the user in printed form on hard goods.

30. The method as claimed in claim 24, wherein the value receiving step comprises the step of receiving a value from the user using graphical user interface means.

31. The method as claimed in claim 24, wherein the validation step comprises the steps of comparing the value received from the user with values stored in the repository and determining if the value received from the user is consumed.

32. The method as claimed in claim 31, wherein the step of determining if the value received from the user is consumed comprises the step of checking a consumption tracking field in a table of the repository.

33. The method as claimed in claim 24, wherein the predetermined content is a digital content access file.

34. The method as claimed in claim 33, further comprising the step of receiving the digital content access file.

35. The method as claimed in claim 33, wherein the digital content access file is one of a digital rights management playback license file and a digital decryption key file.

36. The method as claimed in claim 33, further comprising the step of receiving unencrypted digital content.

37. The method as claimed in claim 36, wherein the unencrypted digital content is one of a digital media file and a digital text file.

38. The method as claimed in claim 36, further comprising the steps of copy-protecting the unencrypted digital content and generating a digital content access file to access the digital content.

39. The method as claimed in claim 38, wherein the copy-protection steps comprise the steps of encrypting digital files and generating an associated digital decryption key to decrypt the encrypted digital file.

40. The method as claimed in claim 38, wherein the copy-protection steps comprise the steps of copy-protecting a digital content file using digital rights management means and generating an associated digital file containing playback usage rights to access the copy-protected digital content file.

41. The method as claimed in claim 33, further comprising the steps of receiving non-digital content and converting the non-digital content into the digital content.

42. The method as claimed in claim 33, further comprising the step of distributing the encrypted digital content access file to the user.

43. The method as claimed in claim 33, wherein the content distribution step comprises the step of electronically sending the digital content access file to the user.

44. The method as claimed in claim 24, further comprising the step of displaying products available for purchase in response to the value.

45. The method as claimed in claim 24, wherein the predetermined content is one of a lottery number and a rewards program point.

46. The method as claimed in claim 45, further comprising the step of storing a winning lottery number and a value redemption by the user.

47. The method as claimed in claim 45, further comprising the step of storing the reward program point and a value redemption by the user.

48. The method as claimed in claim 24, further comprising the step of charging a fee for the purchase of the value.

49. The method as claimed in claim 48, wherein the charging step comprises charging a fee to the user using graphical user interface means.

50. A computer data signal embodied in a carrier wave and representing sequences of instructions which, when executed by a processor, cause the processor to perform a method of distributing content, the method comprising the steps of:
generating a value;
associating the value with a predetermined content;
storing information regarding the value;
distributing the value to users;
receiving the value from a user;
verifying the validity of the received value; and
distributing access to the predetermined content in response to a valid value.

51. A computer program product for use in the execution in a computer for a system for distributing content, the system comprising:
a generation unit for generating a value and for associating the value with a predetermined content;
a repository for storing information regarding the value;
a value distribution unit for distributing the value to users;
a value receiving unit for receiving the value from a user;
a validation unit for verifying the validity of the received value; and
a response unit for distributing access to the predetermined content in response to a valid value.
